(19) United States
(12) Patent Application Publication
(10) Pub. No.: US 2022/0131834 A1
(43) Pub. Date: Apr. 28, 2022

(54) DEVICE, METHOD AND COMPUTER PROGRAM FOR PROVIDING COMMUNICATION FOR A CONTROL APPLIANCE OF A VEHICLE, METHOD, CENTRAL DEVICE AND COMPUTER PROGRAM FOR PROVIDING AN UPDATE, CONTROL APPLIANCE, AND VEHICLE

(71) Applicant: Volkswagen Aktiengesellschaft, Wolfsburg (DE)

(72) Inventors: Ulrich Kleine, Gifhorn (DE); Christian Gierds, Berlin (DE); Anna-Katharina Geldner, Wolfsburg (DE)

(21) Appl. No.: 17/271,558

(22) PCT Filed: Aug. 27, 2019
(86) PCT No.: PCT/EP2019/072768

§ 371 Date: Feb. 25, 2021

(30) Foreign Application Priority Data
Aug. 29, 2018 (DE) 10 2018 214 686.1

(51) Int. Cl. H04L 9/40; H04W 4/40

(52) U.S. Cl. CPC H04L 63/0236; H04L 63/123; H04L 63/20; H04W 4/40

(57) ABSTRACT

Technologies and techniques for providing communication for a control appliance of a vehicle e to update a control appliance and a vehicle. An interface is provided for communication via a vehicle communication channel for the control appliance. The communication is based on information about authorized communication of the control appliance via the vehicle communication channel. The information includes at least one communication rule relating to the communication of the control appliance. The interface is configured such that it is independent from the control appliance such that the information about the authorized communication is protected from access by the control appliance. An updating message relating to the information about the authorized communication of the control appliance is identified via the vehicle communication channel. Information about the authorized communication is updated on the basis of the updating message. The updating of the information is independently carried out by the control appliance.

### RELATED APPLICATIONS

The present application claims priority to International Pat. App. No. PCT/EP2019/072768 to Kleine et al., filed Aug. 27, 2019, titled “Device, Method and Computer Program for Providing Communication for a Control Appliance of a Vehicle, Central Device and Computer Program for Providing an Update, Control Appliance, and Vehicle”, which claims priority to German Patent Application No. 10 2018 214 686.1 to Kleine et al., filed Aug. 29, 2018, the contents of each being incorporated by reference in their entirety herein.

### FIELD OF TECHNOLOGY

The present disclosure relates to a device, a method, and a computer program that enables a control unit in a vehicle to communicate, a method, a central device and a computer program for providing an update, a control unit, and a vehicle.

### BACKGROUND

Vehicles include numerous different vehicle components, from the drive modules such as the drive and the motor, to communication modules such as a vehicle-to-vehicle communication interface or a cellular interface, as well as comfort functions such as seat heating systems. Many of these vehicle components comprise control units or are controlled by control units. These control units are frequently connected to one another in modern vehicles via a vehicle communication channel, such as a vehicle bus or an internal network within the vehicle. Connecting the various control units via a vehicle communication channel may involve some risk, at least in some cases, because an attacker who is able to gain access to the vehicle communication channel by manipulating a control unit may be able to compromise other control units.

WO 2018/077528 A1 discloses identification of manipulation in a Controller Area Network (CAN bus) by checking CAN identifiers. In checking CAN identifiers, it is checked whether messages received by a control unit have been sent by a compromised device or malicious entity. This enables identification of malicious packets, but this identification must then be carried out by all control units, which may involve updating the firmware for the control units with every modification of a control unit in the vehicle.

There is therefore a need for an improved communication concept for communication between control units in a vehicle, which offers a greater security against malicious attacks.

### SUMMARY

Some examples disclosed herein are based on the fact that an additional device can be incorporated between a control unit and a vehicle communication channel, which enables communication with the control unit via the vehicle communication channel, and which is independent of the control unit, and may not be controlled by the control unit. This device includes communication rules regarding authorized communication by the control unit, and can decide, on the basis of this information, which messages from the control unit can be transmitted via the vehicle communication channel, and which messages received via the vehicle communication channel can be transmitted to the control unit. In order to separate the control unit from this device, in at least some exemplary embodiments this device is either implemented separately from the control unit, or at least the information regarding authorized communication is shielded against access by the control unit. Updating the information via authorized communication is carried out via the vehicle communication channel, independently of the control unit.

In some examples, a method is disclosed for establishing communication with a control unit in a vehicle. The method comprises providing an interface to the control unit for communication via the vehicle communication channel. The communication is based on information regarding authorized communication by the control unit via the vehicle communication channel. The information regarding authorized communication may include one or more communication rules regarding the communication by the control unit via the vehicle communication channel. The interface may be independent of the control unit, such that the information regarding authorized communication is shielded against access by the control unit. The method may also include identification of an update message in the communication via the vehicle communication channel. The update message relates to the information regarding authorized communication by the control unit via the vehicle communication channel. The method may also include updating the information via the vehicle communication channel. The method may also update the information regarding authorized communication based on the update message.

The information regarding authorized communication may be updated independently of the control unit. By updating the information regarding the authorized vehicle communication via the vehicle communication channel, a device that enables the control unit to communicate via the vehicle communication channel can be updated independently thereof, thus enabling this device to be sealed off from the control unit, as well as protecting the communication by the control unit, independently of the manufacturer of the control unit.

In at least some exemplary embodiments, the method may also include shielding the information regarding authorized communication against access by the control unit. As a result, the communication by the control unit via the vehicle communication channel is even protected if the control unit itself is compromised. Consequently, the control unit can be prevented from communicating via the vehicle communication channel using fake identifiers. By way of example, shielding the information regarding authorized communication can comprise storing the information regarding authorized communication in a protected memory sector. The information regarding authorized communication can be protected by the protected memory sector in the control unit in the exemplary embodiments.

### BRIEF DESCRIPTION OF THE DRAWINGS

Other advantageous embodiments shall be described below in greater detail based on the exemplary embodiments shown in the drawings, to which exemplary embodiments, in general, the present disclosure as a whole is not limited. Therein:

FIGS. 1a and 1b show flow charts of exemplary embodiments of a method for enabling communication by a control unit in a vehicle;

FIG. 1c shows a block diagram of an exemplary embodiment of a device for enabling communication by a control unit in a vehicle;

FIG. 2a shows a flow chart for an exemplary embodiment of a method for providing an update for a device for enabling communication by a control unit in a vehicle;

FIG. 2b shows a block diagram of an exemplary embodiment of a central device for providing an update for a device enabling communication by a control unit in a vehicle; and

FIG. 3 shows a schematic illustration of devices that communicate via a vehicle communication channel in a vehicle.

### DETAILED DESCRIPTION

Various exemplary embodiments shall now be described in greater detail in reference to the drawings in which some exemplary embodiments are shown. The thicknesses of lines, layers and/or regions in the figures may be intentionally exaggerated for purposes of clarity.

In the following description of the drawings, which only show a few exemplary embodiments, identical reference symbols refer to identical or comparable components. Group reference symbols can also be used for components and objects appearing numerous times in an exemplary embodiment or drawing, which are collectively described with regard to one or more features. Components or objects given the same group reference symbols may be identical with respect to individual, numerous, or all features, e.g., their dimensions, but can also differ, as long as not otherwise explicitly or implicitly specified in the description.

Although exemplary embodiments can be modified and altered in various ways, the exemplary embodiments in the figures are presented as examples and shall be explained comprehensively herein. It should be noted that it is not the intention to limit exemplary embodiments to the respective disclosed forms, but rather, exemplary embodiments should cover all functional and/or structural modifications, equivalents and alternatives lying within the scope of the present disclosure. Identical reference symbols indicate identical or similar elements throughout the descriptions of the drawings.

It should be noted that if an element is described as being “connected” or “coupled” to another element, it can be connected or coupled directly to the other element, or other elements may lie between the two. If an element is described as being “directly connected” or “directly coupled” to another element, no other elements lie between the two. Other terms that are used to describe the relationship between various elements should be interpreted similarly (e.g., “between” as opposed to “directly between,” “adjacent” as opposed to directly “adjacent,” etc.).

The terminology used herein is used only for describing certain exemplary embodiments, and should not limit the exemplary embodiments. As used herein, the singular forms “a,” “one,” and “the” should also include the plural form, as long as the context does not clearly indicate otherwise. It should also be noted that expressions such as, e.g., “contain,” “containing,” “include,” “comprise,” “comprising,” and/or “including,” as used herein, indicate the presence of the specified features, whole numbers, steps, work sequences, elements, and/or components, but does not exclude the addition of one or more features, whole numbers, steps, work sequences, elements, components, and/or groups thereof.

As long as it is not otherwise specified, all of the terminology used herein (including technical and scientific terminology) have the same meaning attributed thereto by a person having ordinary skill in the art to which the exemplary embodiments belong. It should also be noted that expressions such as those defined in general dictionaries are to be interpreted as though they have the meaning that is consistent with the meaning thereof in the context of the relevant technology, and are not to be interpreted in an idealized or excessively formal sense, as long they are not expressly defined otherwise herein.

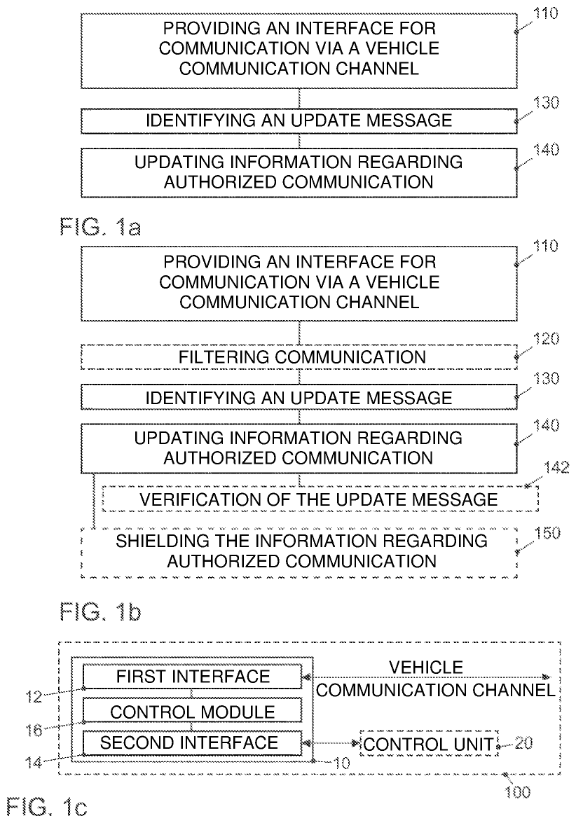

FIGS. 1a and 1b show flow charts for exemplary embodiments of a method for enabling communication by a control unit 20 in a vehicle 100. The method includes providing 110 an interface for communication by the control unit 20 via a vehicle communication channel. The communication may be based on information regarding authorized communication by the control unit 20 via the vehicle communication channel. The information regarding authorized communication comprises one or more communication rules regarding the communication by the control unit 20 via the vehicle communication channel. The interface may be independent of the control unit 20, such that the information regarding authorized communication is shielded against access by the control unit 20. The method includes identifying 130 an update message in the communication via the vehicle communication channel. The update message relates to the information regarding authorized communication by the control unit 20 via the vehicle communication channel. The method includes updating 140 the information regarding authorized communication based on the update message. The updating 140 of the information regarding authorized communication is independent of the control unit 20.

FIG. 1c shows a block diagram of an exemplary embodiment of a corresponding device 10 for enabling communication by a control unit 20 in a vehicle 100. The device 10 includes a first interface 12, configured for communication via a vehicle communication channel in the vehicle. The device 10 also includes a second interface 14, configured for communication with the control unit 20. The device 10 also includes a control module 16, which is coupled to the first interface 12 and the second interface 14. The control module 16 can be configured to execute the steps of the method described in reference to FIGS. 1a and 1b. The control module 16 may be configured to provide an interface for communication via the vehicle communication channel by the control unit 20 via the first interface 12 and via the second interface 14. The communication may be based on information regarding authorized communication by the control unit 20 via the vehicle communication channel. The information regarding authorized communication includes one or more communication rules regarding communication by the control unit 20 via the vehicle communication channel. The control module 16 may be configured such that the interface is independent of the control unit, such that the information regarding authorized communication is shielded against access by the control unit 20. The control module 16 may be configured to identify an update message in the communication via the vehicle communication channel. The update message relates to the information regarding authorized communication by the control unit 20 via the vehicle communication channel. The control module 16 may be configured to update the information regarding authorized communication based on the update message. The control module 16 may be configured to update the information regarding authorized communication independently of the control unit. FIG. 1c also shows the vehicle 100 with the device 10, and a control unit 20, wherein the device 10 is separate from the control unit 20, under one example.

At least some exemplary embodiments relate to enabling communication by a control unit via a vehicle communication channel in a vehicle. Control units in a vehicle are generally devices configured to control and/or monitor vehicle components in a vehicle. The control units are usually included in the vehicle components. In at least some exemplary embodiments, a control unit may be dedicated to (exactly) one vehicle component. The vehicle components are frequently made by suppliers, and the control units for the vehicle components are programed and set by the suppliers. In order to enable full functionality of the vehicle components, the control units are usually connected to a central entity in the vehicle, via a vehicle communication channel that transmits commands for the vehicle component to the control unit for the vehicle component in the vehicle, and/or receives status information for the vehicle component from the control unit. If a control unit is compromised, other control units may be compromised in some systems via the vehicle communication channel.

At least some exemplary embodiments are configured to prevent such a compromising.

The method includes providing 110 an interface for communication via a vehicle communication channel by the control unit 20. Providing 110 the interface for communication via the vehicle communication channel can enable the control unit 20 to communication via the vehicle communication channel. By way of example, providing 110 the interface for communication via the vehicle communication channel can comprise forwarding messages in the vehicle communication channel to the control unit 20 and forwarding messages from the control unit 20 via the vehicle communication channel (for other control units or for a central entity in the vehicle via the vehicle communication channel). The control module 16 can be configured, e.g., to provide the interface for the communication via the vehicle communication channel by the control unit 20 via the first interface 12, and via the second interface 14. By way of example, the control module 16 can be configured to provide the interface for the vehicle communication channel via the second interface 14. The communication by the control unit 20 via the interface for the communication via the vehicle communication channel can be transmitted via the first interface 12. By way of example, the control module 16 can be configured to receive messages from the vehicle communication channel for the control unit 20 via the first interface 12, and to forward them to the control unit 20 via the second interface 14. The control module 16 can be configured to receive messages from the control 20 for the vehicle communication channel (for other control units or a central entity in the vehicle, via the vehicle communication channel) via the second interface 14, and to forward them via the first interface 12.

The interface for the communication by the control unit 20 via the vehicle communication channel may be independent of the control unit 20, such that the information regarding authorized communication is shielded against (reading and/or writing) access by the control unit. In other words, the interface can be provided such that (only) the control unit 20 may be able to use the interface for the communication via the vehicle communication channel. At the same time, the interface can be provided such that the control unit 20 may be shielded against control by the interface (for changes in the information regarding authorized communication). By way of example, the interface can be provided by an entity, e.g., the device 10, which is separate from the control unit 20.

The vehicle communication channel can be a vehicle bus, for example. By way of example, the vehicle components can be configured to interconnect numerous control units in the vehicle 100. In at least some exemplary embodiments, the vehicle communication channel can correspond to an element from the following group: CAN bus (Control Area Network bus), LIN (Local Interconnected Network), FlexRAy, MOST (Media Oriented System Transport), K-Line, SAE J1850 (Society of Automotive Engineers Standard J1850) and Ethernet. The first interface 12 can be configured to communicate via at least one element in the following group: CAN bus, LIN, FlexRAY, MOST, K-Line, SAE J1850, and Ethernet.

Communication by the control unit 20 via the vehicle communication channel may be based on the information regarding authorized communication by the control unit via the vehicle communication channel. In other words, communication by the control unit 20 via the vehicle communication channel may be enabled, if the information regarding authorized communication allows this. The information regarding authorized communication includes one or more communication rules (filters) regarding communication by the control unit 20 via the vehicle communication channel. Communication by the control unit 20 via the vehicle communication channel can be restricted, monitored, and/or filtered based on the one or more communication rules. In some exemplary embodiments, the method includes filtering 120 (or monitoring) the communication by the control unit via the vehicle communication channel based on information regarding authorized communication. Communication via the vehicle communication channel can be based, e.g., on communication identifiers. The communication identifiers can define, e.g., a source (transmission identifier) and/or a target for a message (reception identifier). The information regarding authorized communication can define, e.g., which communication identifiers are authorized (or not authorized) for communication by the control unit 20 via the vehicle communication channel. By way of example, the information regarding authorized communication can include information regarding at least one authorized transmission identifier for the control unit 20, and/or information regarding at least one authorized reception identifier for the control unit 20. The information regarding authorized communication can also include information regarding transmission identifiers that allow transmission of messages to the control unit 20. The communication identifiers, e.g., the transmission identifier and/or the reception identifier, can correspond, for example, to identifiers for a CAN communication protocol.

In at least some of the exemplary embodiments, the information regarding authorized communication includes information regarding at least one authorized transmission identifier for the control unit 20. The filtering 120 of communication by the control unit 20 via the vehicle communication channel can include filtering an outgoing communication by the control unit 20 via the vehicle communication channel based on the information regarding the at least one authorized transmission identifier for the control unit 20. By way of example, filtering communication by the control unit 20 via the vehicle communication channel can include blocking messages by the control unit 20, when an unauthorized transmission identifier may be used. By way of example, filtering 120 communication by the control unit 20 via the vehicle communication channel can include blocking an outgoing communication by the control unit 20 based on the information regarding the at least one transmission identifier for the control unit 20.

Additionally or alternatively, filtering 120 communication by the control unit 20 via the vehicle communication channel can include forwarding only those messages that contain an (authorized) reception identifier for the control unit 20, to the control unit 20. Messages not intended for the control unit 20, or not having an (authorized) reception identifier for the control unit 20, can be blocked and/or not forwarded. By way of example, the information regarding authorized communication can include information regarding at least one authorized reception identifier for the control unit 20. Filtering 120 communication by the control unit 20 via the vehicle communication channel can include filtering an incoming communication for the control unit based on the information regarding the at least one authorized reception identifier for the control unit 20. Filtering 120 communication by the control unit 20 via the vehicle communication channel can include blocking or not forwarding messages that do not include at least one authorized reception identifier for the control unit 20. In some exemplary embodiments, the information regarding authorized communication can also include information regarding one or more authorized transmission identifiers from other control units. The information regarding one or more authorized transmission identifiers from other control units can include, e.g., transmission identifiers from one or more other control units that are authorized to send messages to the control unit 20 via the vehicle communication channel. The filtering 120 of the communication by the control unit 20 via the vehicle communication channel can include filtering an incoming communication for the control unit based on the information regarding the one or more authorized transmission identifiers from other control units. By way of example, messages for the control unit coming from control units with transmission identifiers in the information regarding the one or more authorized transmission identifiers for other control units are forwarded to the control unit 20, and messages with other transmission identifiers are blocked and/or not forwarded.

In at least some exemplary embodiments, the information regarding authorized communication, the one or more communication rules, includes at least one element of the group of one or more authorized communication identifiers for the communication of the control unit via the communication channel, one or more unauthorized communication identifiers for the communication via the communication channel, an authorized repetition rate for messages for communication via the communication channel, an authorized data output for communication via the communication channel, an authorized message size for communication via the communication channel, an authorized format for messages in communication via the communication channel, an authorized priority for messages in communication via the communication channel, and authorized header data information for messages in communication via the communication channel.

The filtering 120 of the communication by the control unit 20 can include, e.g., forwarding or blocking messages from the control unit 20 for the vehicle communication channel based on one or more elements from the group of an authorized repetition rate for messages for communication via the communication channel, an authorized data output for communication via the communication channel, an authorized message size for communication via the communication channel, an authorized format for messages in communication via the communication channel, an authorized priority for messages in communication via the communication channel, and authorized header data information for messages in communication via the communication channel. The filtering of the communication by the control unit 20 can include, e.g., forwarding or blocking messages intended for the control unit 20 based on one or more elements from the group of an authorized repetition rate for messages for communication via the communication channel, an authorized data output for communication via the communication channel, an authorized message size for communication via the communication channel, an authorized format for messages in communication via the communication channel, an authorized priority for messages in communication via the communication channel, and authorized header data information for messages in communication via the communication channel.

By way of example, the method can include determining a repetition rate for messages coming from the control unit 20 or intended for the control unit 20. The method can include comparing the repetition rate for messages coming from the control unit 20 or intended for the control unit 20 with the authorized repetition rate for messages for communication via the communication channel.

By way of example, the method can also include determining a data output of messages coming from the control unit 20 or intended for the control unit 20. The method can include comparing the data output of messages coming from the control unit or intended for the control unit 20 with the authorized data output for messages for communication via the communication channel.

By way of example, the method can also include determining a message size for messages coming from the control unit 20 or intended for the control unit 20. The method can include comparing the message size for messages coming from the control unit or intended for the control unit 20 with the authorized message size for messages for communication via the communication channel.

By way of example, the method can also include determining a message format for messages coming from the control unit 20 or intended for the control unit 20. The method can include comparing the message format for messages coming from the control unit or intended for the control unit 20 with the authorized message format for messages for communication via the communication channel.

By way of example, the method can also include determining a priority (i.e. a priority identifier stored in the header data of a message) for messages coming from the control unit 20 or intended for the control unit 20. The method can include comparing the priority for messages coming from the control unit or intended for the control unit 20 with the authorized priority for messages for communication via the communication channel.

By way of example, the method can also include determining header data information for messages coming from the control unit 20 or intended for the control unit 20. The method can include comparing the header data information for messages coming from the control unit or intended for the control unit 20 with the authorized header data information for messages for communication via the communication channel.

The method includes identifying 130 an update message in the communication via the vehicle communication channel. By way of example, the update message can include an update identifier. The identifying 130 can include identifying the update identifier for the update message. If a message includes the update identifier, the method can identify 130 it as an update message. In at least some exemplary embodiments, identifying 130 the update message includes checking whether the update message relates to and/or includes the information regarding authorized communication for the control unit 20. In at least some exemplary embodiments, the update identifier may be dedicated to (just) the control unit 20. By way of example, different control units in the vehicle can be assigned different update identifiers.

The method also includes updating 140 the information regarding authorized communication based on the update message. By way of example, the update message can include all of the information regarding authorized communication. In this case, updating the information regarding authorized communication can correspond to a replacement of the information regarding authorized communication with the information regarding authorized communication in the update message. Alternatively, the update message can include an updated portion of the information regarding authorized communication. In this case, updating the information regarding authorized communication can correspond to a partial replacement of the information regarding authorized communication, or supplementing the information regarding authorized communication with the information regarding authorized communication in the update message.

Updating 140 the information regarding authorized communication may be independent of the control unit 20. In other words, the information regarding authorized communication may be updated without the need for or possibility of intervention by the control unit 20. By way of example, the method can also include shielding the updating 140 of the information regarding unauthorized communication. By way of example, access to the interface for communication via the vehicle communication channel by the control unit 20 can be blocked or prevented while updating the information regarding authorized communication.

In at least some exemplary embodiments, updating 140 the information regarding authorized communication also includes, as shown in FIG. 1b, verification 142 of the update message. By way of example, verification of the update message can correspond to checking whether the update message is valid. The update message can be valid, for example, if it comes from an authorized source for update messages, and if it has not been manipulated by a third party. By way of example, verification 142 of the update message can be based on a cryptographic method. By way of example, at least a portion of the update message can be signed or encrypted based on an asymmetrical or symmetrical cryptographic method. In an asymmetrical method, the portion of the update message can be signed or encrypted based on a private key (i.e. from a vehicle manufacturer or a manufacturer of vehicle components). The verification can include checking a signature in the update message or decrypting the portion of the update message based on a public key (for example, from the vehicle manufacturer, or a manufacturer of vehicle components). In a symmetrical method, the portion of the update message can be signed or encrypted based on a common secret. The verification can include checking a signature in the update message or decrypting the portion of the update message based on the common secret.

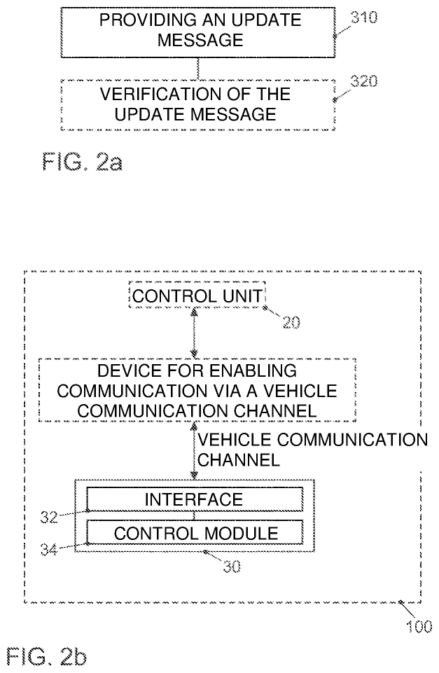

In at least some exemplary embodiments, the verification query may be based on the update message. By way of example, the verification query can include the update message or a portion of the update message (i.e. in an encrypted or signed form). Alternatively or additionally, the verification query can include a hash value for at least a portion of the update message. The verification answer can include information regarding whether the update message/portion of the update message, or hash value included in the verification query in at least a portion of the update message was transmitted by an authorized source for update messages (i.e. a central device 30, as shown in FIG. 2b).

In at least some exemplary embodiments, the verification 142 of the update message may be based on a question-answer method (also referred to as a challenge-response method). The verification 142 of the update message can include transmitting a verification query to a central entity in the vehicle, and receiving a verification answer from the central entity in the vehicle. The verification of the update message can be based on the verification question and the verification answer. By way of example, the question-answer method can be based on a cryptographic method. By way of example, the verification answer can include an encrypted version of the verification query. Alternatively or additionally the verification answer can include a signed version of the verification query. The question-answer method can be based on both an asymmetrical cryptographic method as well as a symmetrical cryptographic method.

If the verification 142 determines that the update message is fake, the update message can be ignored. If the verification 142 determines that the update message is fake numerous times (i.e. numerous times within a predefined time period), all update messages can be ignored, for example, until restarting the vehicle 100.

In some exemplary embodiments, the method also includes, as shown in FIG. 1b, shielding 150 the information regarding authorized communication against access by the control unit 20. By way of example, shielding 150 the information regarding authorized communication against access by the control unit 20 can include preventing or hindering reading or manipulating the information regarding authorized communication by the control unit 20. By way of example, shielding 150 the information regarding authorized communication against access by the control unit 20 can block (or hinder) access to the information regarding authorized communication via the second interface 14 by the control unit 20. Shielding 150 the information regarding authorized communication can include, e.g., storing the information regarding authorized communication in a protected memory sector. The method can also include protecting the protected memory sector based on a cryptographic method. By way of example, shielding 150 the information regarding authorized communication can include encrypting the information regarding authorized communication or monitoring the information regarding authorized communication based on a hash function. In at least some exemplary embodiments, the control unit 20 includes the device 10. The control module 16 can be configured to shield the information regarding authorized communication against access by the control unit 20.

In at least some exemplary embodiments, the vehicle 100 can be, e.g., a land vehicle, boat, aircraft, rail vehicle, road vehicle, automobile, off-road vehicle, motor vehicle, or truck.

The first interface 12 and/or the second interface 14 (and an interface 32, introduced in conjunction with FIG. 2b) can have one or more inputs, and/or one or more outputs, for receiving and/or transmitting information, for example, in digital bit signs, based on a code, within a module, between modules, or between modules of different entities.

The control module 16 in the exemplary embodiments (and/or a control module 34, introduced in conjunction with FIG. 2b) can be an arbitrary controller, processor, or programmable hardware component. By way of example, the control module 14 can also be in the form of software programmed for a corresponding hardware component. In this regard, the control module 16; 34 can be implemented in the form of programmable hardware with the appropriate software. Digital processors, such as digital signal processors (DSPs) can be used for this. The exemplary embodiments are not limited to a specific type of processor. Numerous, as well as multiple, processors could be used to implement the control module 16; 34.

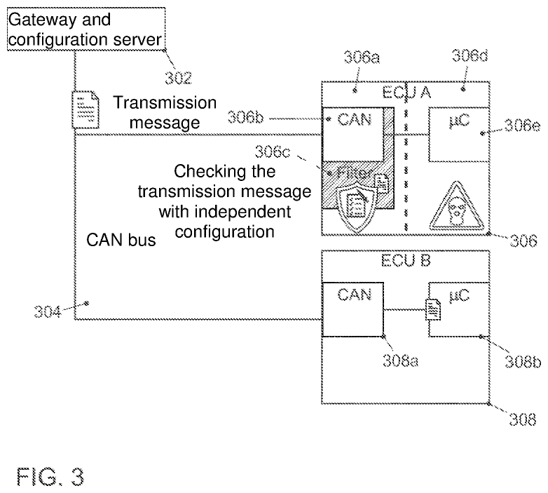

More details and aspects of the method and the device 10 shall be specified in conjunction with the concept or examples that have been described above or shall be described below (e.g., in reference to FIGS. 2a to 3). The device 10 and the method can include one or more additional features corresponding to one or more aspects of the proposed concept or the described examples, as they have been described above or shall be described below.

FIG. 2a shows a flow chart for an exemplary embodiment of a method for providing an update to a device 10 to enable communication by a control unit 20 in a vehicle 100. The method includes providing 310 an update message to the device 10 to enable communication by the control unit 20 via the vehicle communication channel. The update message relates to information regarding authorized communication by the control unit 20 via the vehicle communication channel. The information regarding authorized communication includes one or more communication rules regarding communication by the control unit 20 via the vehicle communication channel. By way of example, the method can be executed by a central device 30 in the vehicle.

FIG. 2b shows a block diagram of an exemplary embodiment of a (corresponding) central device 30 for providing an update to a vehicle 10 enabling communication by a control unit 20 in a vehicle 100. The central device 30 includes an interface 32, configured for communication via a vehicle communication channel. The central device 30 includes a control module 34 configured to enable communication by the a control unit 20 via the interface 32 and the vehicle communication channel. The update message relates to information regarding authorized communication by the control unit 20 via the vehicle communication channel. The information regarding authorized communication includes one or more communication rules regarding communication by the control unit 20 via the vehicle communication channel. The interface 32 is coupled to the control module 34. The control module 34 can also be configured to execute other steps in the method shown in FIG. 2a. FIG. 2b also shows the vehicle 100, comprising the device 30, the device 10, and the control unit 20.

In at least some exemplary embodiments, the update message can be provided by a central entity in the vehicle, such as a central device 30, to the devices for enabling communication by control units (i.e. control unit 20). The central device 30 can be, for example, a central administrative device in the vehicle. In some exemplary embodiments, the central device can be an administrative device for the vehicle communication channel, such as a gateway or a security element for the vehicle communication channel.

The method includes providing 310 an update message to the device 10 to enable communication by a control unit 20 via the vehicle communication channel. By way of example, the provision of the update can correspond to providing 310 the update message. The method can include transmitting the update message via the vehicle communication channel. In at least some exemplary embodiments, update messages can be provided to numerous control units (or their devices for enabling communication via the vehicle communication channel). The update message includes, for example, the information regarding authorized communication by the control unit 20.

In some exemplary embodiments, the method also includes verification 320 of the update message by receiving a verification query from the device, checking the verification query based on the update message, and transmitting a verification answer to the device, if the checking of the verification query is successful. In at least some exemplary embodiments, the verification query can be encrypted or signed. Checking the verification query can include checking whether the encryption or signature of the verification query is valid, if the encryption query from the device 10 was encrypted or signed, and the encryption query has not been subsequently manipulated. By way of example, the method can include determining the verification answer based on the verification query. By way of example, the method can include decrypting, encrypting, or signing the verification query to determine the verification answer.

In at least some exemplary embodiments, the verification query is based on the update message. By way of example, the verification query can include the update message, or a portion of the update message (e.g., in encrypted or signed form), as it would be received by the device 10. Alternatively or additionally, the verification query can include a hash value for at least a portion of the update message, as it would be received by the device 10. The verification answer can include information regarding whether the update message/portion of the update message, or hash value for at least a portion of the update message, corresponds to the provided 310 update message. If the central device 30 did not provide 310 an update message, the verification of the update message is unsuccessful.

More details and aspects of the central device 30 and the method shall be specified in conjunction with the concept or examples that have been described above (e.g., in reference to FIGS. 1a and 1b) or shall be described below (e.g., in reference to FIG. 3). The central device 30 and the method can include one or more additional features corresponding to one or more aspects of the proposed concept or the described examples, as they have been described above, or shall be described below.

FIG. 3 shows a schematic illustration of devices that communicate via a vehicle communication channel in a vehicle. FIG. 3 shows a gateway and configuration server 302, corresponding to the central device 30 in FIG. 2b. This is connected to a first control unit 306 and a second control unit 308 via a CAN bus 304 corresponding to the vehicle communication channel. The first control unit corresponds to the control unit 20 in the exemplary embodiments. The control unit includes a first region 306a, corresponding to the device 10 in FIG. 1c, which has a CAN communication module 306b, formed by the first interface 12, and a filter 306c, formed by the control module 16. The first control unit 306 also includes a second region 306d, corresponding to the control unit 20 in the exemplary embodiments. The second region includes a microcontroller 306e, which may be coupled to the first region. As shown in the illustration, the second region in the first control unit can be compromised. The transmission message sent via the CAN bus 306 may be checked in the first control unit with an independent configuration. FIG. 3 also shows the second control unit 308, which is not divided into a first and second region. The second control unit includes a CAN communication module 308a and a microcontroller 308b, which may be coupled to the CAN communication module 308a.

More details and aspects shall be specified in conjunction with the concept or examples that have been described above (e.g., in reference to FIGS. 1a to 2b) or shall be described below. The entities shown in FIG. 3 may contain one or more additional features corresponding to one or more aspects of the proposed concept or the described examples, as they have been described above or shall be described below.

A CAN controller that can be configured via the bus may be formed in the exemplary embodiments.

At least some exemplary embodiments may be configured with a hardware filter in CAN control units for preventing spoofing (faking an identity) and flooding (mass sending of messages) attacks. In at least some other systems, it is not possible to configure the filters such that they can be upgraded, and can also be converted independently of the supplier. In such systems, the configurations are frequently introduced by the control software, and this internal filtering may have some weaknesses, or require one hundred percent trustworthiness on the part of the supplier.

The CAN communication may be configured in some systems via a corresponding data set in the control unit. The CAN reception filter as well as the scope of CAN identifiers that are to be transmitted, can be determined via this data set. The software in the control unit normally has full control over configuration in such systems.

If certain configurations are part of the control software, the correct implementation may depend on the control software. Because, despite intensive checking of the software, problems and weaknesses can never be entirely eliminated, there may be no guarantee in these systems that the configuration will be implemented correctly. Furthermore, there may be no generic way to centrally manage (e.g., in a central gateway) configurations of the control units for CAN, at least in some systems, and to distribute these, as needed, to the control units. Changes in the communication relationships in a vehicle could therefore be updated once, centrally, and then distributed. There is also the risk that the configuration key that should be protected becomes widely used, and its trustworthiness can no longer be ensured.

At least some exemplary embodiments contain an independent control entity (e.g., for enabling communication by a control unit in a vehicle) for checking and potentially discarding CAN messages.

In some exemplary embodiments, a separate control unit for external filtering can be connected upstream of the relevant control unit, or the control unit can be isolated on a separate CAN, and the filtering can take place in the gateway. This can result in higher costs in some variations, as well as reducing installation space. In addition, the isolation of the control units on their own CAN may be limited by the possible number of CAN controllers on most microcontrollers.

At least some exemplary embodiments disclosed herein enable a central administration of the CAN communication, e.g., through the gateway, by the transmission of the updates via the CAN bus. In this way, a vehicle manufacturer can react simply to the deferral of functionality in the vehicle, without requiring comprehensive updates for the control units. Furthermore, the configuration in many exemplary embodiments may be independent of the control software and the potential weaknesses therein. It can be demanded that the CAN hardware is a checked and certified required component.

Exemplary embodiments may include a communication controller for a vehicle communication channel, i.e. a CAN (Controller Area Network) or a MOST (Media Oriented System Transport), that can be configured via the bus. At least some exemplary embodiments contain a secure, supplier-independent, and flexible introduction of a configuration in an independent control entity.

The communication controller in an ECU (Electronic Control Unit, or control unit) may be configured as a central interface between a component and a vehicle bus (a vehicle communication channel). This configuration may utilize a central filtering with respect to receiving and transmitting messages. This filtering affects the security level of the ECU, for which reason corresponding security requirements for the filtering configuration may be increased. If the configuration could be altered from within the ECU itself, messages could be received or faked by the ECU. This becomes particularly critical if the ECU, its software environment, or its domains (e.g., infotainment online) are not trustworthy. The idea behind at least some exemplary embodiments is therefore to carry out the configuration, not with the ECU, but instead, independently thereof, via the bus, through trustworthy systems of the OEM. The ECU itself, in at least some exemplary embodiments, is unable to alter the configuration.

By way of example, a CAN controller (e.g., a device for enabling communication by a control unit in a vehicle) can be configured to react to specific CAN identifiers. If the messages in question (e.g., update messages) arrive at the CAN (e.g., the vehicle communication channel), the CAN hardware may process the configuration that was introduced, and use it for configuring a filter list/white list (lists in which permitted/authorized communication parameters are entered, for example, through updating the information regarding authorized communication), e.g., if a control unit wants to send a message that it is not authorized to send, it is blocked by a hardware filter, for example (e.g., through monitoring the communication of the control unit). The transmission protocol can be specific to the OEM, the CAN identifier for configuration transmission can be anchored in the CAN hardware.

In some examples, the communication controller can be configured to support use by safe authentication and identification mechanisms. The transmission protocol can be specific to the OEM (Original Equipment Manufacturer), the identifiers for configuration transmission can be anchored, such as in the controller hardware. At least some exemplary embodiments contain suitable scenarios for updating the configuration (e.g., the information regarding authorized communication), such as updating the ECU software, to prevent disrupting normal operation of the vehicle through improper triggering. By way of example, the communication controller can respond to the identifier for the update with a challenge (demanding a corresponding answer be sent) to a central unit in the vehicle. If the results of numerous C&R (challenge-response) processes are negative, the update queries can be ignored, for example, until the next start-up of the vehicle. In the transmission via the vehicle bus, a central administration of the communication may be enabled by the gateway. In this way, a vehicle manufacturer can react simply to the deferral of functionality in the vehicle, without requiring comprehensive updates for the control units. The configuration can be independent of the control software and the potential weaknesses therein, for example, if the control unit itself is compromised, control over the configuration can be prevented, such that the configuration remains protected. It can be demanded that the controller hardware is a checked and certified required component.

Because of the device, in at least some exemplary embodiments, a separate communication controller for control units, such as media control units, may become superfluous, because the protection for vehicle communication is located in the standardized hardware in the controller.

In some examples, a computer program is provided for executing at least one of the methods described above when the program runs on a computer, a processor, or a programmable hardware component. Another exemplary embodiment includes a digital storage medium that is machine or computer readable and has electronically readable control signals that can interact with a programmable hardware component such that one of the methods described above is executed.

The features disclosed in the above description, the following claims, and the attached drawings may be of significance and implemented individually as well as in arbitrary combinations to obtain an exemplary embodiment in its various designs.

Although some aspects are described in conjunction with a device, it should be understood that these aspects also describe the corresponding method, such that a block or a component in a device can also be understood as a corresponding method step or as a feature of a method step. Analogously, aspects described in conjunction with one or more method steps also represent a description of a corresponding block or detail or feature of a corresponding device.

Depending on the determined implementation requirements, exemplary embodiments of the present disclosure can be implemented in hardware or software. The implementation be carried out using a digital storage medium, e.g. a floppy disk, DVD, Blu-Ray disc, CD, ROM, PROM, EPROM; EEPROM, or a FLASH memory, hard disk, or some other magnetic or optical memory, on which electronically readable control signals are stored, which interact with a hardware component such that the respective method is carried out.

A programmable hardware component can be formed by a processor, central processing unit (CPU), graphics processing unit (GPU), computer, computer system, application-specific integrated circuit (ASIC), integrated circuit (IC), system on chip (SOC), programmable logic unit, or field programmable gate array (FPGA).

The digital storage medium can therefore be machine or computer readable. Some exemplary embodiments therefore include a data carrier that has electronically readable control signals that are capable of interacting with a programmable computer system or programmable hardware component such that one of the methods described herein may be carried out. One exemplary embodiment is therefore a data carrier (or digital storage medium or computer readable medium), on which the program for executing one of the methods described herein is recorded.

In general, exemplary embodiments of the present disclosure can be implemented as a program, firmware, computer program, or computer program product with a program code, or as data, wherein the program code or the data is or are able, in this regard, to carry out one of the methods when the program runs on a processor or a programmable hardware component. The program code or the data can be stored, e.g. on a machine readable carrier or data carrier. The program code or the data can be in the form of source code, machine code, or byte code, or other intermediate codes.

Another exemplary embodiment includes a data stream, signal burst, or a sequence of signals that represent(s) the program for executing one of the methods described herein. The data stream, signal burst, or sequence of signals can be configured, e.g., to be transferred via the internet or some other network. Exemplary embodiments are therefore also data-representing signal sequences, that are suitable for transmission via a network or a data communication connection, wherein the data represent the program.

A program according to an exemplary embodiment can implement one of the methods while it is being executed, in that it reads out locations or writes data therein, such that switching procedures or other procedures are triggered in transistor structures, reinforcement structures, or other components functioning according to electrical, optical, magnetic, or other principles. Accordingly, by reading a location, data, values, sensor values, or other information can be obtained, determined, or measured by a program. A program can therefore obtain, determine or measure sizes, values, measurement values and other information by reading one or more locations, as well as trigger, cause, or execute an action, as well as activate other devices, machines, and components, by writing in one or more locations.

Accordingly, in the various examples provided above, information regarding authorized communication can be updated and also include verification of the update message. As a result, a fake or malicious update message may be prevented from compromising communication via the vehicle communication channel.

In some examples, the verification of the update message can be based on a cryptographic method. The cryptographic method can be used to verify that the update message comes from a trustworthy source and/or was not manipulated during transmission.

In some examples, verification of the update message can be based on a question-and-answer method. The verification of the update message can include transmitting a verification question to a central agency for the vehicle, and receiving a verification answer from the central agency for the vehicle. The verification can be based on the verification question and the verification answer. In this manner, it may be possible to check and/or determine whether the update message actually came from the central agency.

Communication filtering may also be performed by the control unit via the vehicle communication channel through the interface based on the information regarding authorized communication. This filtering can prevent unauthorized communication by the control unit or to the control unit.

In some examples disclosed above, the information regarding authorized communication includes information regarding at least one authorized transmission identifier for the control unit. Filtering communication by the control unit via the vehicle communication channel can include filtering outgoing communication by the control unit via the vehicle communication channel based on the information regarding the at least one authorized transmission identifier for the control unit. As a result, the control unit, if it is obtained through a fake identifier, can be prevented from compromising other control units. In at least some exemplary embodiments, filtering the communication by the control unit via the vehicle communication channel includes blocking an outgoing communication by the control unit based on the information regarding the at least one authorized transmission identifier for the control unit. In this manner, the control unit can be prevented from compromising other control units if it is compromised by a fake identifier.

In some examples disclosed above, the information regarding authorized communication may include information regarding at least one authorized reception identifier for the control unit. The filtering of the communication by the control unit via the vehicle communication channel can include filtering incoming communication for the control unit based on the information regarding the at least one authorized reception identifier for the control unit. In this manner, it may be possible to prevent reception of messages from control units with invalid identifiers, or messages not intended for the control unit, by the control unit.

In some examples disclosed above, the information regarding authorized communication includes at least one element from the group of one or more authorized communication identifiers for communication by the control unit via the communication channel, one or more unauthorized communication identifiers for communication via the communication channel, an authorized repetition rate for messages in communication via the communication channel, an authorized data output for communication via the communication channel, an authorized message size for communication via the communication channel, an authorized format for messages in communication via the communication channel, an authorized priority for messages in communication via the communication channel, and authorized header data information for messages in communication via the communication channel. These parameters can be used to distinguish between authorized and unauthorized communication.

Technologies and techniques are provided for updating a device in order to enable a control unit in a vehicle to communicate. An update message may be provided for the device that enables a control unit to communicate via the vehicle communication channel. The update message may relate to information regarding authorized communication by the control unit via the vehicle communication channel. The information regarding authorized communication includes one or more communication rules regarding communication by the control unit via the vehicle communication channel. By updating the information regarding authorized vehicle communication via the vehicle communication channel, a device that enables the control unit to communicate via the vehicle communication channel can be updated independently thereof, therefore enabling this device to be sealed off from the control unit, as well as protecting the communication by the control unit independently of the manufacturer of the control unit.

In some examples, the update message may be verified by receiving a verification question from the device, checking the verification query based on the update message, and transmitting a verification answer to the device, if the checking of the verification query is successful. In this manner, it may be possible to confirm that the update message actually comes from the central agency.

A program is also provided, wherein the program includes program code for executing at least one of the methods when the program code may be executed on a computer, a processor, a controller, or a programmable hardware component.

A device is also disclosed above for enabling communication by a control unit in a vehicle. The device may include a first interface configured for communication via a vehicle communication channel in the vehicle. The device may also include a second interface configured for communication with the control unit. The device may also include control module, where the control module may be configured to provide an interface for communication by the control unit via the first interface and via the second interface. The communication may be based on information regarding authorized communication by the control unit via the vehicle communication channel. The information regarding authorized communication includes one or more communication rules regarding communication by the control unit via the vehicle communication channel. The control module may be configured such that the interface may be independent of the control unit, such that the information regarding authorized communication may be shielded against access by the control unit. The control module may be configured to identify an update message in the communication via the vehicle communication channel. The update message relates to the information regarding authorized communication by the control unit via the vehicle communication channel. The control module may be configured to update the information regarding authorized communication based on the update message. The control module may be configured to update the information regarding authorized communication independently of the control unit.

In some examples, a control unit with a device is disclosed that enables communication by a control unit in a vehicle. The control module may be configured to shield the information regarding authorized communication against access by the control unit. In this manner, a compromised control unit can be prevented from gaining unauthorized access to the vehicle communication channel.

In some examples, a vehicle is disclosed that includes a device enabling communication by a control unit in a vehicle, and the control unit. The device may be separate from the control unit. This device for enabling communication by a control unit in a vehicle can be incorporated between the control unit and the vehicle communication channel, to protect communication between the control units and various suppliers.

In some examples, a central device is provided for updating a device enabling communication by a control unit in a vehicle. The central device includes an interface configured to communicate via a vehicle communication channel. The central device also includes a control module configured to provide an update message for the device enabling communication by a control unit via an interface and the vehicle communication channel. The update message relates to information regarding authorized communication by the control unit via the vehicle communication channel. The information regarding authorized communication includes one or more communication rules regarding the communication by the control unit via the vehicle communication channel.

The exemplary embodiments described above represent only one exemplification of the principles of the present invention. It should be understood that modifications and variations on the arrangements and details described herein would be clear to other persons skilled in the art. For this reason, it is intended that the present disclosure is only limited by the scope of protection described by the following claims, and not by the specific details presented herein in the description and explanation of the exemplary embodiments.

### LIST OF REFERENCE SYMBOLS

10 device for enabling communication via a vehicle communication channel
12 first interface
14 second interface
16 control module
20 control unit
30 central device
32 interface
34 control module
100 vehicle
110 providing an interface for communication via a vehicle communication channel
120 filtering the communication
130 identifying an update message
140 updating information regarding authorized communication
142 verification of the update message
150 protecting the information regarding authorized communication
302 gateway and configuration server
304 CAN bus
306 first control unit
306a first region in the first control unit
306b CAN communication module for the first control unit
306c filter for the first control unit
306d second region of the first control unit
306e microcontroller for the first control unit
308 second control unit
308a CAN communication module for the second control unit
308b microcontroller for the second control unit
310 providing an update message
320 verification of the update message

1-15. (canceled)

16. A method for operating a control unit in a vehicle, comprising:
receiving a communication comprising information on a communication interface independent of the control unit, wherein the information comprises (i) authorized communication by the control unit via a vehicle communication channel, (ii) one or more communication rules regarding the communication by the control unit via the vehicle communication channel;
identifying an update message in the communication via the vehicle communication channel, wherein the update message relates to the information regarding authorized communication by the control unit via the vehicle communication channel; and
updating the information regarding authorized communication based on the update message, wherein updating the information regarding authorized communication is carried out independently of the control unit.

17. The method of claim 16, wherein receiving the communication comprising information on the communication interface independent of the control unit comprises receiving the communication comprising information on the communication interface that is at least partially inaccessible by the control unit.

18. The method of claim 16, further comprising shielding the information regarding authorized communication from access by the control unit, wherein the shielding of the information regarding authorized communication comprises storing the information regarding authorized communication in a protected memory sector.

19. The method of claim 16, wherein the updating of the information regarding authorized communication comprises verifying the update message.

20. The method of claim 19, wherein the verification of the update message comprises a cryptographic verification.

21. The method of claim 19, wherein the verification of the update message comprises at least one of (i) a question-answer verification, and (ii) sending a verification question to a central entity in the vehicle, and receiving a verification answer from the central entity in the vehicle, wherein the verification is based on the verification question and the verification answer.

22. The method of claim 16, further comprising filtering the communication by the control unit via the vehicle communication channel, via the interface, based on the information regarding authorized communication.

23. The method of claim 22, wherein the information regarding authorized communication comprises information regarding at least one authorized transmission identifier for the control unit,
and/or wherein filtering communication by the control unit via the vehicle communication channel comprises filtering outgoing communication by the control unit via the vehicle communication channel based on the information regarding at least one authorized transmission identifier for the control unit,
and/or wherein filtering communication by the control unit via the vehicle communication channel comprises blocking an outgoing communication from the control unit based on the information regarding the at least one authorized transmission identifier for the control unit.

24. The method of claim 22, wherein the information regarding authorized communication comprises information regarding at least one authorized reception identifier for the control unit,
wherein filtering communication by the control unit via the vehicle communication channel comprises filtering an incoming communication for the control unit based on the information regarding the at least one authorized reception identifier for the control unit.

25. The method of claim 16, wherein the information regarding authorized communication comprises at least one element from the group of
(i) one or more authorized communication identifiers for the communication by the control unit via the communication channel,
(ii) one or more unauthorized communication identifiers for the communication via the communication channel,
(iii) an authorized repetition rate for messages for the communication via the communication channel,
(iv) an authorized data output for the communication via the communication channel,
(v) an authorized message size for the communication via the communication channel,
(vi) an authorized format for messages for the communication via the communication channel,
(vii) an authorized priority for messages for the communication via the communication channel, and/or
(viii) an authorized header information for messages for the communication via the communication channel.

26. An apparatus for communications with a control unit in a vehicle, comprising:
a first interface, for communicating via a vehicle communication channel; and
a second interface for communicating with the control unit; and
a control module configured to
receive, via the first interface and second interface, a communication comprising information, wherein the information comprises (i) authorized communication by the control unit via a vehicle communication channel, (ii) one or more communication rules regarding the communication by the control unit via the vehicle communication channel;
identify an update message in the communication via the vehicle communication channel, wherein the update message relates to the information regarding authorized communication by the control unit via the vehicle communication channel; and
update the information regarding authorized communication based on the update message, wherein updating the information regarding authorized communication is carried out independently of the control unit.

27. The method of claim 26, wherein receiving the communication comprising information on the communication interface independent of the control unit comprises receiving the communication comprising information on the communication interface that is at least partially inaccessible by the control unit.

28. The method of claim 26, further comprising shielding the information regarding authorized communication from access by the control unit, wherein the shielding of the information regarding authorized communication comprises storing the information regarding authorized communication in a protected memory sector.

29. The method of claim 26, wherein the updating of the information regarding authorized communication comprises verifying the update message.

30. The method of claim 29, wherein the verification of the update message comprises one of
a cryptographic verification;
a question-answer verification; and
sending a verification question to a central entity in the vehicle, and receiving a verification answer from the central entity in the vehicle, wherein the verification is based on the verification question and the verification answer.

31. The method of claim 26, further comprising filtering the communication by the control unit via the vehicle communication channel, via the interface, based on the information regarding authorized communication.

32. The method of claim 31, wherein the information regarding authorized communication comprises information regarding at least one authorized transmission identifier for the control unit,
and/or wherein filtering communication by the control unit via the vehicle communication channel comprises filtering outgoing communication by the control unit via the vehicle communication channel based on the information regarding at least one authorized transmission identifier for the control unit,
and/or wherein filtering communication by the control unit via the vehicle communication channel comprises blocking an outgoing communication from the control unit based on the information regarding the at least one authorized transmission identifier for the control unit.

33. The method of claim 31, wherein the information regarding authorized communication comprises information regarding at least one authorized reception identifier for the control unit,
wherein filtering communication by the control unit via the vehicle communication channel comprises filtering an incoming communication for the control unit based on the information regarding the at least one authorized reception identifier for the control unit.

34. The method of claim 26, wherein the information regarding authorized communication comprises at least one element from the group of
(i) one or more authorized communication identifiers for the communication by the control unit via the communication channel,
(ii) one or more unauthorized communication identifiers for the communication via the communication channel,
(iii) an authorized repetition rate for messages for the communication via the communication channel,
(iv) an authorized data output for the communication via the communication channel,
(v) an authorized message size for the communication via the communication channel,
(vi) an authorized format for messages for the communication via the communication channel,
(vii) an authorized priority for messages for the communication via the communication channel, and/or
(viii) an authorized header information for messages for the communication via the communication channel.
